(19) United States
(12) Patent Application Publication
(10) Pub. No.: US 2025/0043602 A1
(43) Pub. Date: Feb. 6, 2025

(54) MOTOR-VEHICLE LOCK

(71) Applicant: KIEKERT AKTIENGESELLSCHAFT, Heiligenhaus (DE)

(72) Inventors: Peter SZEGENY, Engelskirchen (DE); Thomas SCHÖNENBERG, Burscheid (DE); Holger SCHIFFER, Meerbusch (DE); Michael SCHOLZ, Essen (DE); Ömer INAN, Dorsten (DE)

(73) Assignee: KIEKERT AKTIENGESELLSCHAFT, Heiligenhaus (DE)

(21) Appl. No.: 18/718,202

(22) PCT Filed: Dec. 16, 2022
(86) PCT No.: PCT/DE2022/100964

§ 371 Date: Jun. 10, 2024

(30) Foreign Application Priority Data
Dec. 21, 2021 (DE) 10 2021 133 981.2

(51) Int. Cl. E05B 85/26

(52) U.S. Cl. CPC E05B 85/26

(57) ABSTRACT

A motor vehicle, having a locking mechanism with a rotary latch and at least one catch, with a latching element arranged in an engagement region between the rotary latch and the catch, wherein the latching element can be pivoted, and at least held, on the rotary latch, and wherein at least one means for continuously guiding the latching element is provided on the motor-vehicle lock.

The invention relates to a lock for a motor vehicle, having a locking mechanism with a rotary latch and at least one catch, with a latching element arranged in an engagement region between the rotary latch and the catch, wherein the latching element is pivotably mounted, and can at least be held, on the rotary latch.

Locking systems or vehicle locks are subject to continuous further development, wherein the development must adapt to constantly increasing comfort conditions for the user. One comfort function for the user is to ensure that the door lock is easy to open. It has proven to be essential that the locking mechanism arranged in the motor-vehicle lock can be opened with the least possible force. If the locking mechanism can be opened with little force, it is possible to undertake the unlocking of the locking mechanism by means of an electric drive. For example, a switching means can be arranged on an outside door handle, wherein the switching means can be actuated by means of the outside door handle, and a control signal can be transmitted to the motor-vehicle lock by means of the switching means. The control signal activates the electric motor, which then initiates the opening of the locking mechanism. In order to realize this comfort function in all functional positions and in particular in extreme situations, it must be possible to unlock the locking mechanism easily.

In the main locking position of the motor-vehicle lock, in which the rotary latch interacts with a lock holder and is engaged by means of the catch, the locking mechanism is usually subjected to maximum load. The load on the locking mechanism results largely from the door seal pressure against which the motor-vehicle lock must hold the side door, for example, in the sealing and closing position. If the motor-vehicle lock is then opened, the catch must be moved out of engagement with the rotary latch to open the locking mechanism. Various solutions from the prior art have become known for making unlocking the locking mechanism as easy as possible.

One solution approach is disclosed in DE 10 2019 123 825 A1. A latching element is arranged between the rotary latch and the catch, wherein the latching element rolls off the catch when the locking mechanism is opened or unlocked. The rolling-off process causes the rotary latch to move into an opening position in certain regions, so that a first seal back pressure as a force component in the locking mechanism can be reduced. By means of the rolling-off process of the locking mechanism parts and the latching element, easy unlocking of the locking mechanism can be realized. If the catch and rotary latch of conventional locking mechanisms are usually pulled apart, a noise is produced during the parting, which is also referred to as an opening bang. The rolling-off process of the locking mechanism parts or the latching element on the catch, on the other hand, causes a pressure or force to be reduced in the locking mechanism and ultimately results in a sliding between the catch and the latching element. Consequently, an easy and quiet opening of the locking mechanism can be realized.

A corresponding modification of the use of a latching element is known from DE 10 2019 123 825 A1. Here as well, a latching element is arranged between the catch and the rotary latch, so that a rolling-off process occurs when the locking mechanism is unlocked. For rolling off the latching element, the latching element moves in a locking mechanism plane, wherein the latching element performs a tilting movement in the rotary latch. The guidance of the latching element is realized by means of a guide extension on the latching element and by a casing around the rotary latch. Furthermore, the latching element can be held in the rotary latch by means of a spring means, so that the latching element can always be moved back to its initial position.

In principle, the prior art has proven itself, but can be improved.

The object of the invention is to provide an improved motor vehicle lock. In particular, it is the object of the invention to improve a motor-vehicle lock with a latching element arranged between the rotary latch and the catch in such a way that an alignment of the latching element can be realized over the entire range of movement of the rotary latch with the simplest design means.

According to the invention, the object is achieved by the features of independent claim 1. Advantageous embodiments are specified in the dependent claims. However, it should be noted that the exemplary embodiments described in the following are not limiting; rather, any number of possible variations of the features described in the description, the claims, and the drawings are possible.

According to claim 1, the object of the invention is achieved by providing a motor-vehicle lock having a locking mechanism with a rotary latch and at least one catch, with a latching element arranged in an engagement region between the rotary latch and the catch, wherein the latching element can be pivoted, and at least held, on the rotary latch, and wherein at least one means for continuously guiding the latching element is provided on the motor-vehicle lock. Due to the guide means, which continuously guides the latching element after unlocking the locking mechanism, the position of the latching element can be determined at any point in time, and the latching element can be guided in the correct position during the opening process of the locking mechanism. Thus, a secure positioning of the latching element can be realized at any point in time using the simplest design means.

When the invention refers to a motor-vehicle lock, this comprises locks and locking systems that are used to hold a component that is movably arranged on the motor vehicle. Examples include flaps, hoods, side doors, sliding doors, covers, and/or load compartments, i.e., components that are movably arranged on the motor vehicle and must be held in a fixed position during operation.

The specified vehicle locks have a locking mechanism with a rotary latch and at least one catch. The rotary latch is rotatably mounted in the motor-vehicle lock, usually on a metal axle, and works together with a lock holder. The lock holder and motor-vehicle lock can be arranged on the body or on the moving component. When the locking mechanism is closed, the motor-vehicle lock, and in particular the rotary latch, interacts directly with the lock holder and is held in at least one latching position by means of the catch. There are locking mechanisms with one or two latches and one, two, or more catches. Locking mechanisms with a rotary latch and two latching positions are preferred, e.g., in a side door, whereas single-latching locking mechanisms are usually used for locking systems in front seats.

The invention relates to motor-vehicle locks with which a transmission element is provided in the engagement region between the rotary latch and the catch. The transmission element can also be referred to as a latching element, since at least one latching surface for the rotary latch is formed on the transmission element. Preferably, the latching element forms the main latching position of the locking mechanism. The latching element is received in a pivotally mounted manner in the rotary latch in such a way that, starting from a main latching position, a rolling-off process occurs between the latching element and the catch when the locking mechanism is unlocked. The latching element is pivotally mounted in the rotary latch for this purpose. Pivotably mounted means that the latching element is able to support itself relative to a metal core and on the metal core of the rotary latch, and perform a tilting or pivoting movement.

It can be advantageous if the latching element can be guided at least in certain regions by means of the catch. The latching element is released from the rotary latch after the locking mechanism is unlocked. The latching position is released, and the rotary latch moves along the catch. In an advantageous way, the catch can be used to guide the latching element. The locking mechanism is designed such that the rotary latch can move past the catch, at least in certain regions, so that an outer edge of the catch can be used to guide the latching element. Thus, the catch serves, on the one hand, to latch the rotary latch in a preliminary and/or main latch and, at the same time, to be available as a guide means for the latching element after unlocking the locking mechanism. Thus, the latching element is released from a latching surface of the catch after unlocking or disengaging the latch, but is guided along the catch after unlocking.

In addition to guiding the latching element by means of the catch, it can be advantageous if the latching element can be guided at least in certain regions by means of a guide rib. In addition to guiding the latching element, there may consequently be a rib that is able to guide the latching element after the locking mechanism has been unlocked. This can be particularly advantageous if, due to the arrangement of the rotary latch and the catch, the guidance of the latching element through the catch is possible only to a limited extent or is not possible. Thus, it can be ensured that a guide means is always available for the latching element mounted in the rotary latch.

The guide rib can be part of a lock housing and/or a lock case. The guide rib is arranged in the motor-vehicle lock such that the latching element can engage with the guide rib after the locking mechanism has been unlocked. It is also conceivable that a combination of guide rib and guide by means of the catch can be present. After disengagement from the main latching position, the rotary latch is released, wherein, after the latching element has rolled off the catch, the latching element can be positioned by the catch and/or the guide rib, i.e., it can be guided in a position by the catch and the guide rib. For this purpose, the guide rib can, for example, be formed in one piece with the lock housing made of plastic. In other words, the guide rib is formed directly with the manufacture of the lock housing, a cover cap of the lock housing, or the housing cover. It is also possible for the guide rib to be made of a different plastic with respect to the lock housing material. This plastic can have special guiding and/or sliding properties so that an easy, low-noise movement of the catch is made possible. The guide rib can, for example, be connected to the lock housing as a separate plastic component or designed as a composite material, preferably using a two-component injection-molding process.

Alternatively or together, the guide rib can also be formed from a part of the lock case. The lock case encloses the lock housing, but it is possible, for example, to form a chamfer in the lock case, so that the chamfer can be used to guide the latching element at least in certain regions. Preferably, the guide rib is made of plastic, wherein the lock case can also be provided with plastic in certain regions, at least in the region of the guide rib.

It can also be advantageous and form a further embodiment of the invention if the guide rib extends along the catch at least in certain regions. By extending the guide rib along the catch, a secure transfer of the latching element from the catch to the guide rib can be ensured. In particular, the latching element can be guided in an almost identical position along the catch and the guide rib. This is particularly advantageous if the latching element moves far enough due to the rotary movement of the rotary latch that the latching element is no longer engaged with the catch. In this case, in which the latching element cannot be fully guided along the catch, the latching element is transferred from the catch to the guide rib during guidance, so that secure and even guidance of the latching element can be ensured over the entire angle of rotation of the rotary latch. If the guide rib is aligned in relation to the catch such that the guide rib extends along the catch, a secure and low-noise guidance of the latching element can be ensured over the entire range of movement of the latching element.

If the guide rib extends into the catch at least in certain regions, an additional advantageous embodiment variant of the invention can be achieved. The guide rib can be formed and arranged, at least in certain regions, along the catch in the motor-vehicle lock. In order to ensure a secure transfer of the latching element from the catch to the guide rib, taking into account that the catch is freely movable and can therefore assume different angular positions, it is proposed according to the invention that the guide rib be placed into the catch at least in certain regions. The guide rib is designed such that the guide rib can extend into a recess or groove-shaped opening in the catch. For this purpose, the catch can have a recess in a plastic casing and/or a metal core. When the catch is moved, this ensures that a seamless transition between the catch and the guide rib is possible at any point in time.

It can also be advantageous if a stop for the catch can be formed by means of the guide rib. Thus, the guide rib can serve to guide the latching element on the one hand, and provide a stop for the catch in a dual function on the other. If, for example, the guide rib is designed in combination with the recess or groove in the catch such that, when the guide rib and the recess or groove interact, the catch can be held or fixed in the main latching position by the guide rib, the guide rib forms a stop for the catch in the main latching position. Additional stops or positioning means for the catch can then be dispensed with if necessary.

If the guide rib has a support bar, the function of the guide rib can be stabilized. The guide rib can extend along the catch, at least in certain regions, so that a space-saving arrangement of the guide rib and the support bar in the motor-vehicle lock can be ensured. By means of the support bar, the durability and fatigue strength of the guide rib can be further increased, and a long service life can be ensured.

It can also be advantageous if, in a deflected position of the catch, a path that can be described as circular arc-shaped can be set, in combination with the guide rib, to guide the latching element. A deflected position of the catch is present if the catch is out of engagement with the rotary latch or the latching element. Thus, the deflected position corresponds to the unlocked position of the locking mechanism. If the catch is deflected by a release lever, the locking mechanism is unlocked, wherein the latching element rolls off the catch and is ultimately released from the catch. The catch is deflected to such an extent that the latching element is capable of moving along the catch and/or the guide rib. This arrangement ensures that the latching element or the transmission element can be moved in the locked and unlocked state at any point in time. As a result, the locking mechanism can be opened quietly on the one hand, and closed securely on the other. Consequently, the guidance of the latching element in an advantageous position with the simplest design means can be ensured.

The invention is explained in more detail below with reference to the accompanying drawings on the basis of a preferred exemplary embodiment. However, the principle applies that the exemplary embodiment does not limit the invention, but is merely an advantageous embodiment. The features depicted can be implemented individually or in combination with further features of the description as well as what is claimed—individually or in combination.

In the figures:

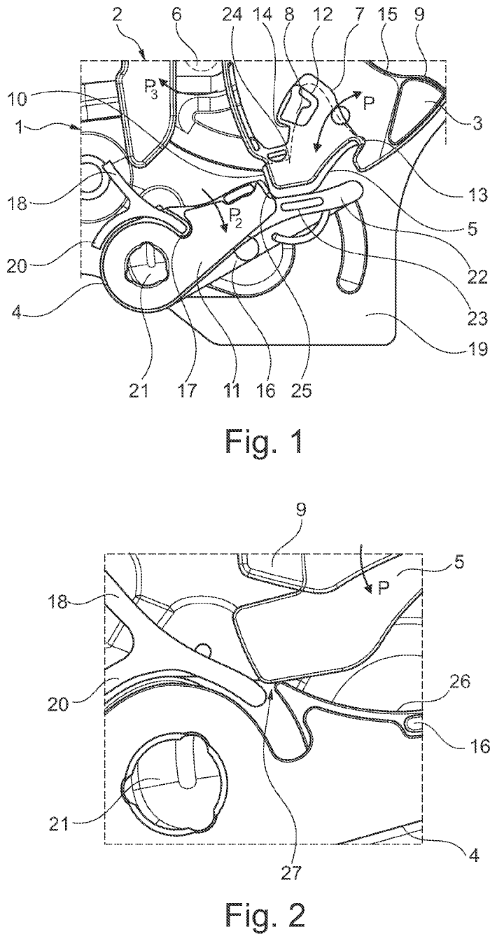

FIG. 1 is a top view of a locking mechanism according to the invention in a main latching position and with a guide rib arranged in the motor-vehicle lock,

FIG. 2 is a detail view of the latching element arranged between the rotary latch and the catch in an unlocked position and in the transition region between the catch and the guide rib, and

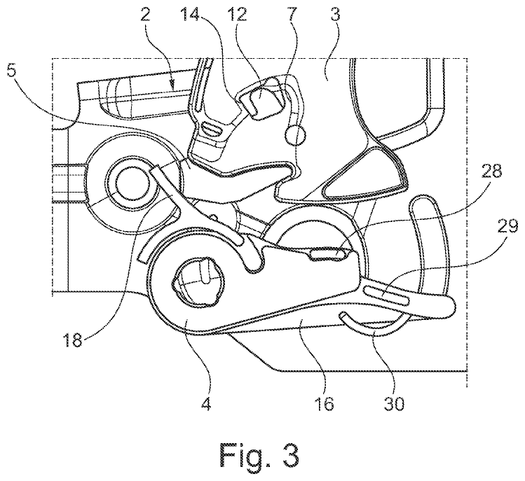

FIG. 3 is in turn a view of the locking mechanism according to the invention, wherein the rotary latch is shown in an open position, and the latching element is positioned by the guide rib.

FIG. 1 shows motor-vehicle lock 1 in its essential components for explaining the disclosure of the invention. The motor-vehicle lock 1 comprises a locking mechanism 2 with a rotary latch 3 and a catch 4. Between the rotary latch 3 and the catch 4, a latching element 5 is received in a pivotally mounted manner in the rotary latch 3. FIG. 1 shows the main latching position of the locking mechanism 2. In the main latching position, a lock holder 6 is in engagement with the rotary latch 3 so that, for example, a side door can be locked by means of the motor-vehicle lock 1. In this respect, the main latching position of the locking mechanism 2 is shown. In the main latching position, the latching element 5 rests with an abutment surface 7 against a recess 8 of the rotary latch 3.

The rotary latch 3 has a plastic casing 9, wherein the latching element 5 is received in the rotary latch 3 at least in certain regions by means of the plastic casing 9. As can be clearly seen in FIG. 1, the plastic casing 9 almost completely covers the latching element 5, wherein only one latching surface on the latching element 5 projects from the plastic casing 9 in certain regions. Thus, it is ensured that the latching surface 10 comes into engagement with the metal core 11 of the catch 4. The latching element 5 is preferably also designed as a metallic component and preferably as a stamped and embossed part.

The latching element has an extension 12 on one side, wherein the extension 12 can be moved in the recess 8. When the latching element 5 is pivoted in the direction of the arrow P around the bearing point 13, the extension 12 can thus be moved between the abutment surfaces 7 and 14. The pivot angle of the latching element 5 in the rotary latch 3 can thus be delimited by means of the extension 12.

Consequently, the latching element 5 rests in certain regions against a plastic casing 9 of the rotary latch and comes into engagement with the metal core 15 at the bearing point 13, for example. In the region of the abutment surfaces 7, 14, the metal latching element engages with the plastic casing 9 of the rotary latch 3.

The catch 4 has a metal core 11 and also a plastic casing 16. The metal core 11 has a notch 17, wherein the notch 17 is also lined with the plastic casing 16. FIG. 1 also shows a guide rib 18, wherein the guide rib 18 extends into the notch 17 of the rotary latch 3. The guide rib 18 can, for example, form a part of a plastic housing of the motor-vehicle lock 1, which is not shown, or can also be formed from the lock case 19. In any case, the guide rib extends around the catch 4 in certain regions and also has a support bar 20. As described above by way of example, the guide rib 18 and the support bar 20 can be formed in one piece with the housing. The support bar 20 surrounds the bearing point 21 of the catch 4, at least in certain regions. As a result, a stiffener can be inserted into the guide rib 18 in a space-saving manner.

It can be seen in FIG. 1 that the plastic casing 16 extends beyond the metal core 11 of the catch 4, wherein the extension 22 has a buffer pocket 23 for damping interaction with the latching element 5. In the main latching position, the latching element 5 rests against the abutment surface 7, the bearing point 13, and the abutment surface 24 on the rotary latch.

If the locking mechanism is now unlocked, e.g., by moving the catch 4 in the direction of arrow P2 by means of a release lever not shown, this is followed by a rolling-off movement of the latching element 5 on the latching surface 25 of the catch, or the latching element 5 rolls on the latching surface 25, wherein, during the rolling-off process, the catch already moves in the opening direction, in the direction of arrow P2, and the rotary latch 3 also rotates clockwise in the direction of arrow P3. During this rolling-off movement, the force acting upon the rotary latch 3, which is generated for example and preferably by the door seal, is already reduced, so that the easy opening of the locking mechanism 2 can be made possible. Consequently, the engagement between the catch 4 and the rotary latch 3 is not pulled apart abruptly in the case of the locking mechanism 2 shown, but the engagement conditions between the rotary latch 3 and the catch 4 change continuously as a result of the pivoting movement of the latching element, until the latching element slides off the latching surface 25 of the catch.

FIG. 2 now shows the open latch, wherein the latching element 5 has moved out of the rotary latch casing 9 in the direction of arrow P. The latching element has moved out of the plastic casing 9 of the rotary latch 3 and, after sliding off the latching surface 25, comes into engagement with the plastic casing 16 of the catch 4. The plastic casing 16 of the catch 4 serves as a guide surface 26 for the latching element 5.

FIG. 2 shows the transition region 27 between the guide surface 26 and the guide rib 18. It can be seen that continuous guidance of the latching element 5 across the opening region of the rotary latch can be ensured by the guide surface 26 and the guide rib 18. Thus, a defined position of the latching element 5 in relation to the rotary latch 3 and the catch 4 can be set at any point in time by means of the guide means 18, 26.

FIG. 3 shows the locking mechanism 2 in a fully open position, i.e., the position in which the rotary latch 3 releases the lock holder, and a tailgate, for example, can be opened. The catch 4 is shown fully pivoted into its end position, and it can be clearly seen that the latching element 5 can always be positioned by the guide rib 18. The latching element is held between the abutment surfaces 7 and 14 by means of the catch 4 or the guide surface 26 and the guide rib 18. In other words, the extension 12 is held in a defined intermediate position between the abutment surfaces 7 and 14 by means of the guide means 18, 26. The latching element 5 is thus located in a definable position during the complete movement of the rotary latch 3, so that positive guidance of the latching element 5 in the locking mechanism plane of the rotary latch 3, latching element 5, and catch 4 can be realized. The locking mechanism plane is characterized by a parallel plane through the catch 4, the latching element 5, and the rotary latch 3. Consequently, all components of the locking mechanism 3, 4, 5 move in the locking mechanism plane and pivot or rotate in the locking mechanism plane.

The plastic casing 16 also has buffer elements 28, 29 and is equipped with a stop buffer 30 for one end position of the catch 4.

### LIST OF REFERENCE SIGNS

1 Motor-vehicle lock
2 Locking mechanism
3 Rotary latch
4 Catch
5 Latching element
6 Lock holder
7, 14, 24 Abutment surface
8 Recess
9, 16 Plastic casing
10, 25 Latching surface
11, 15 Metal core
12 Extension
13 Bearing point
17 Notch
18 Guide rib
19 Lock case
20 Support bar
21 Bearing point
22 Extension
23, 28, 29 Buffer pocket
26 Guide surface
27 Transition region
30 Stop buffer
P, P2, P3 Arrow

1. A motor-vehicle lock comprising:
a locking mechanism with a rotary latch and at least one catch,
a latching element arranged in an engagement region between the rotary latch and the catch, wherein the latching element is pivotably mounted and held, on the rotary latch, and
at least one guide that continuously guides the latching element.

2. The motor-vehicle lock according to claim 1, wherein the guide comprises a portion of the catch that guides the latching element at least in certain regions.

3. The motor-vehicle lock according to claim 1, wherein guide comprises a guide rib that guides the latching element at least in certain regions.

4. The motor-vehicle lock according to claim 23, further comprising a lock housing and/or a lock case, wherein the guide rib is part of the lock housing and/or the lock case.

5. The motor-vehicle lock according to claim 3, wherein the guide rib extends along the catch at least in certain regions.

6. The motor-vehicle lock according to claim 3, wherein the guide rib extends into the catch at least in certain regions.

7. The motor-vehicle lock according to claim 3, wherein the guide rib comprises a stop for the catch.

8. The motor-vehicle lock according to claim 3, wherein the guide rib has a support bar.

9. The motor-vehicle lock according to claim 8, wherein the support bar extends along the catch at least in certain regions.

10. The motor-vehicle lock according to claim 3, wherein the guide rib and the catch form a circular arc-shaped guide path in a deflected position of the catch.

11. The motor-vehicle lock according to claim 2, wherein the guide comprises and outer edge of the catch.

12. The motor-vehicle lock according to claim 1, wherein the guide comprises both a portion of the catch and a guide rib that guide the latching element in different regions.

13. The motor-vehicle lock according to claim 3, further comprising a lock housing, wherein the guide rib is provided on the lock housing, and wherein the guide rib is made of a different plastic material relative to a material of the lock housing.

14. The motor-vehicle lock according to claim 3, further comprising a lock case, wherein the guide rib comprises a chamfer formed on the lock case.

15. The motor-vehicle lock according to claim 6, wherein the catch has a groove-shaped opening and the rib extends into the groove-shaped opening.

16. The motor-vehicle lock according to claim 1, wherein the rotary latch has a plastic casing, and the latching element is received in the rotary latch within the plastic casing with a latching surface of the latching element extending from the plastic casing.

17. The motor-vehicle lock according to claim 9, wherein the support bar surrounds a bearing point of the catch at least in certain regions.
